(19) United States
(12) Patent Application Publication
(10) Pub. No.: US 2008/0156038 A1
(43) Pub. Date: Jul. 3, 2008

(54) Process for Preparing Foamed Glass Granulate

(75) Inventor: Hans-Veit Dennert, Schlusselfeld (DE)

Correspondence Address: BROWDY AND NEIMARK, P.L.L.C.;624 NINTH STREET, NW, SUITE 300, WASHINGTON, DC, 20001-5303, US

(73) Assignee: Dennert Poraver GmbH, Postbauer-Heng (DE)

(21) Appl. No.: 11/817,731

(22) PCT Filed: Mar. 1, 2005
(86) PCT No.: PCT/EP2005/002121

§ 371 Date: Sep. 4, 2007

(51) Int. Cl. C03B 19/08

(52) U.S. Cl. 65/17.6

(57) ABSTRACT

A process for preparing foamed glass granulate comprises the following steps:
provision of an aqueous glass binder slurry containing water at room temperature, a foaming agent and a glass binder in a preparation tank,
addition of glass powder, preferably old glass powder, to the glass binder slurry to form a moist stirrable glass preparation,
homogenisation of the glass preparation thus formed,
transfer of the glass preparation into a stirring tank,
stirring of the glass preparation for a stirring period of between 2 and 6 hours to fuse the glass components at least in part,
addition of further glass powder to the glass preparation in a granulation mixer to form granulate green bodies,
drying of the granulate green bodies and
foaming of the granulate green bodies into foamed glass granulate particles.

The invention relates to a process for preparing foamed glass granulate having the features set out in the preamble of claim 1.

Processes for the preparation of foamed glass granulate are disclosed in documents EP 0 052 693 B1, EP 0 484 643 A1 and EP 0 678 482 B1 of the applicant. In these processes, an aqueous glass binder slurry of water, a foaming agent and water glass as the glass binder is prepared in practice in a known manner in a preparation tank. Hot water at a temperature of about 80° C., which has to be heated with a high energy input, is used for this. Glass powder is added to this glass binder slurry in the preparation tank, forming a moist stirrable glass preparation with a moisture content of 31 to 45%. This glass preparation is homogenised for a mixing period of about 5 minutes once all the glass powder has been added. The glass preparation is subsequently put into a storage tank in the form of a stirring tank, in which the glass preparation is stirred for a stirring period of 50 to 80 minutes to fuse the glass components at least in part. After this stirring period the glass preparation is passed by means of a metering pump into a continuous granulation mixer, in which additional glass powder is also added in a metered fashion so that the moisture content of the glass preparation falls to about 18 to 18.5%. The granulate green bodies formed in the granulation mixer are subsequently dried and foamed, for example in a rotary kiln, to form foamed glass granulate particles at temperatures of about 800° C.

A drawback of the known process is that, when heating the water to form the aqueous glass binder slurry, a high energy input is required for what is known as “hot fusion”. It is in principle also desirable to be able to prepare the foamed glass granulate particles to be as strong as possible in order to make them as pressure-resistant and mechanically stable as possible in view of their all-round application in a wide range of products.

Starting from this problem the object of the invention is to improve the known process for foamed glass granulate production so that granulate particles of greater strength are achieved using less energy.

This object is achieved by the features set out in the characterising part of claim 1 and basically consists of what is known as “cold fusion” with a long stirring period. That is to say that, according to the invention, the water for forming the glass binder slurry is to be added at about room temperature so absolutely no energy is required for heating the water. To compensate for this, the stirring period in the stirring tank is adjusted to a period of between 2 and 6 hours. Because of this considerably longer stirring period, which can be compensated for in the production process by a correspondingly large stirring tank or by a plurality of stirring tanks, surface fusion of the glass powder particles occurs, resulting in a type of paste or gel formation on the particle surface. This improves the mutual adhesion of the particles when forming the granulate green bodies and thus the strength of the actual foamed glass granulate particles after foaming. In this regard tests have shown that an increase in strength of up to 30% can be achieved, compared to the values in foamed glass granulate produced in the conventional manner.

Preferred parameters and further steps of the process according to the invention are set out in the sub-claims, the process being described in more detail in the following embodiment. 970 litres of water at room temperature, 900 kg of hot water glass as the glass binder and 45 kg of a conventional foaming agent, such as sugar, manganese dioxide or sodium carbonate, are placed in a preparation tank and mixed for a short time. Depending on the temperature of the water glass, this glass binder slurry then has a temperature of about 31 to 40° C.

1,330 kg of recovered glass powder with a particle size of 0.1 mm is added over a period of approx. 30 to 40 minutes, thus forming a moist stirrable glass preparation with a moisture content of 39 to 45%. This glass preparation is homogenised for a mixing period of about 5 minutes and is subsequently put into an unheated large stirring container. The glass preparation is then stirred in the container as a batch for a stirring period of between 2 and 6 hours, preferably about 4 to 5 hours, so as to fuse the glass components of the glass preparation at least in part. Reactive glass powder particles are formed, which because of the gel layer on their surface—as can be assumed—ensure that the subsequent granulate particles are thoroughly “baked”.

After the aforementioned stirring period the glass preparation is sent via a metering pump to a continuous granulation mixer, into which further glass powder is mixed to form granulate green bodies. Additional granulate green bodies with a particle size of preferably 0.25 to 0.5 mm are also added as a granulate nucleating agent. The content by weight is about 4 to 8% based on the total weight of glass preparation and added glass powder.

The granulate green bodies prepared in this way are passed onto a granulation disc where the granulate green bodies are subsequently granulated to a greater average particle size. The granulate green bodies are also dried in a granulation drier to a residual moisture content of 0.1% and classified into differing granulate particle sizes by sieving before foaming. Typical particle size categories lie, for example, within the following diameter ranges: 0.25 to 0.5 mm, 0.5 to 1.0 mm, 1.0 to 2.0 mm, 2.0 to 4.0 mm and 4.0 to 8.0 The corresponding granulates are subsequently foamed in the conventional manner in a rotary kiln at a temperature of approx. 790° C.

1-10. (canceled)

11. A process for preparing foamed glass granulate comprising the following steps:
provision of an aqueous glass binder slurry containing water which is added at about room temperature, a foaming agent and a glass binder in a preparation tank,
addition of glass powder to the glass binder slurry to form a moist stirrable glass preparation,
homogenisation of the glass preparation thus formed,
transfer of the glass preparation into a stirring tank,
stirring of the glass preparation for a stirring period of between 2 and 6 hours to fuse the glass components at least in part,
addition of further glass powder to the glass preparation in a granulation mixer to form granulate green bodies,
drying of the granulate green bodies, and foaming of the granulate green bodies to form foamed glass granulate particles.

12. Process according to claim 11, wherein recovered glass powder is used as glass powder for the glass binder slurry.

13. Process according to claim 11, wherein water glass at a temperature above room temperature is used as a glass binder.

14. Process according to claim 13, wherein the glass binder slurry has a temperature of about 30 to 40° C.

15. Process according to claim 11, wherein the stirring period for fusing the glass components is between 3.5 and 4.5 hours.

16. Process according to claim 11, wherein during the addition of glass powder in the continuous mixer additional granulate green bodies are added as a granulate nucleating agent.

17. Process according to claim 16, wherein the granulate green bodies have a particle size of 0.25 to 0.5 mm.

18. Process according to either claim 16, wherein the addition of the granulate green bodies is carried out in a mass ratio of about 4 to 8% based on the mass of glass preparation and added glass powder.

19. Process according to claim 11, wherein the granulate green bodies are granulated on a granulation disc.

20. Process according to claim 11, wherein the granulate green bodies are dried to a residual moisture content of approx. 0.1%.

21. Process according to claim 11, wherein the dried granulate green bodies are classified into differing granulate body sizes by sieving before foaming.
